(19) United States
(12) Patent Application Publication
(10) Pub. No.: US 2011/0244586 A1
(43) Pub. Date: Oct. 6, 2011

(54) Method for Potentiometric Analysis of Fluoride in Biological Material

(75) Inventors: Kalman Nagy, Oslo (NO); Thor Anders Aarhaug, Jacobsli (NO)

(73) Assignee: SINVENT AS, Trondheim (NO)

(21) Appl. No.: 13/059,704

(22) PCT Filed: Sep. 8, 2009
(86) PCT No.: PCT/NO2009/000313

§ 371 Date: Jun. 9, 2011

(30) Foreign Application Priority Data
Sep. 8, 2008 (NO) 2008 3858

(51) Int. Cl. G01N 27/00; G01N 27/26

(52) U.S. Cl. 436/124; 205/779

(57) ABSTRACT

The present invention concerns a method for potentiometric analysis of fluoride in biological material, where the biological material is wet extracted and analysed for fluoride content in the same beaker, and where the sample is dissolved in an acid at pH lower than 2. Further, the invention concerns use of the method of analysis of fluorides in aluminium industry and glass-works.

### CROSS-REFERENCE TO RELATED APPLICATIONS

This application is a 35 U.S.C. §371 national stage application of PCT/NO2009/000313 filed Sep. 8, 2009, which claims the benefit of Norwegian Application No. 20083858 filed Sep. 8, 2008, both of which are incorporated herein by reference in their entireties for all purposes.

### STATEMENT REGARDING FEDERALLY SPONSORED RESEARCH OR DEVELOPMENT

Not applicable.

### INVENTION AREA

The invention concerns a method for analysis of fluoride with low detection limit and short analysis time for biological materials. The invention also concerns fluoride analysis in the presence of interfering species.

The invention is generic for analysis of fluoride in aqueous solutions. The invention has superior tolerance for aluminium ion interference, often the case for biological material found near primary aluminium production sites and glassworks.

### BACKGROUND OF THE INVENTION

Potentiometric analysis with fluoride ion selective electrode is a well-established methodology. The benefit for this method is a low instrumental cost and fast, precise analysis.

Fluoride selective electrodes measure fluorine in the form of fluoride. Other fluorine-containing species are not detected. Since the activity of fluoride is a function of pH, this parameter must remain constant during analysis. For an analytical representation of fluoride concentration, the activity coefficient must be buffered, to keep the relation between activity and concentration constant. This is often performed by using Total Ionic Strength Adjustment Buffer (TISAB). In the pH range 5 to 5.5 the TISAB effectively counteracts changes in pH. The use of commercially available electrodes and TISAB-buffer yields a detection limit of about 1 μM. Limiting for the sensitivity is the solubility of the electrode material, lanthanum fluoride. Leakage of fluoride from the electrode into the solution was investigated by Baumann (Anal. Chim. Acta, 54 (1971) pp. 189-197). By adding thorium or zirconium the lanthanum fluoride leakage was strongly inhibited and a detection limit down to 10⁻¹⁰ M was observed. By using protons or lanthanum, a detection limit close to 10⁻⁸ M was obtained.

The most significant interference for fluoride selectivity of the electrode is the hydroxyl ion. Thus, the presence of hydroxyl ions will result in too high estimates of fluoride concentration.

Electrode kinetics for fluoride electrodes is slower for higher pH values, and results in longer analysis times. For online analysis methodology the detection limit is influenced by the electrode response time. Moritz (Sensors and Actuators B, 13-993) pp. 217-220, Sensors and Actuators B, 15-16 (1993) pp. 223-227) has studied the sensitivity of fluoride for ion selective field effect transistors (ISFET). He found that a pH of about 2 is optimal for electrode response time and sensitivity. Tyler (Archs. oral Biol., 34 (1989) pp. 995-997) has analysed saliva at pH 1.2 by using a differentiated cell composed of one fluoride and pH combination electrode. At the measured pH, the difference between the electrodes represents the total fluoride content in the solution, i.e. hydrogen fluoride and fluoride. The methodology requires instrumentation where two high-impedance inputs can be differentiated. Patent application GB A 2273780 indicates fluoride analysis in acids at pH <2.

Fluoride forms complexes and precipitates with several cations. Examples include aluminium, iron, calcium and magnesium. For fluoride analysis in matrices containing interfering complexes it is necessary to add reagent that binds the cation stronger than fluoride, to release fluoride. TISAB buffers, for example, contain CDTA, a standard complexing agent for metal ions.

For fluoride analysis in biological samples, samples are traditionally pretreated by ashing, alkaline fusion or acid extraction. Ashing and alkaline fusion are generally time and cost demanding steps due to the temperature changes involved. The purpose of the present invention is to reduce time and cost of analysis. This is achieved by combining acid extraction with fast and sensitive analysis at low pH where this is performed in the one and same analysis beaker.

Acid extraction of fluoride is commonly used for analysis of biological samples. One advantage is that extraction can be performed at room temperature. This methodology has been evaluated by Stevens (Commun. Soil Sci. Plant. Anal. 26 (1995) pp. 1823-42). In order to make extraction time shorter, the use of ultrasound is possible.

### BRIEF DESCRIPTION OF THE INVENTION

The invention provides a method for potentiometric analysis of fluoride in biological samples where the biological material is wet extracted and the content of fluoride is analysed in the same beaker, where the sample is dissolved in acid with a pH lower than 2.

In order to obtain low pH-values, acid is employed. Hydrochloric acid is especially preferred. Because interfering cations are present (aluminium) in the sample, phosphoric acid is preferably added for complexation or precipitation of cations as phosphates. Hydrochloric acid can be use separately or in combination with phosphoric acid. The method is applicable for continuous monitoring of fluoride.

Examples of relevant applications include analysis of fluoride in aluminium primary production and glassworks.

For determination of fluoride in biological matrices like grass and needles, samples are dried and grounded and then acid is added to extract fluorine, complexate interfering cations and to provide optimal conditions for the analysis.

### SHORT DESCRIPTION OF THE FIGURES

FIG. 1 shows fluoride as function of pH in pure water (25° C.).

FIG. 2 shows a pre dominance diagram for complexation and precipitation of Al-fluorides.

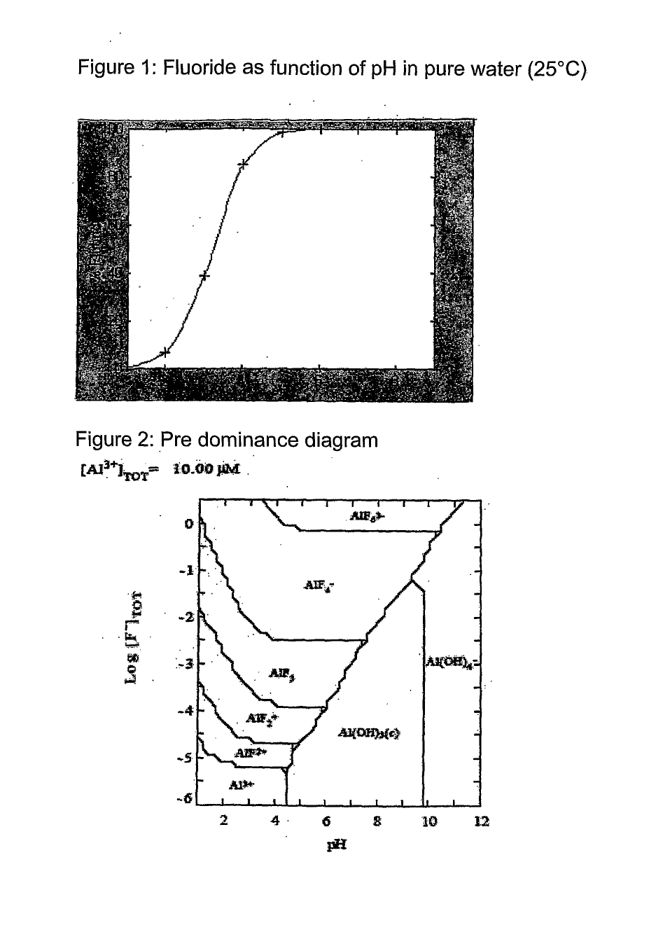

### DETAILED DESCRIPTION OF THE INVENTION

By performing analysis at pH values significantly lower than the acid constant of hydrogen fluoride (HF, pKa=3.2), a low pH dependence of the fluoride concentration is obtained in addition to high ionic strength. This is illustrated with table data from Gmelin's Handbuch der anorganishen Chemie (Vol 5: fluorine) where the fraction of free fluoride is given as a function of pH. In the pH range 0-2 the curve has a relatively low slope.

In the low pH range the hydroxyl ion is absent. The electrode response is very fast and approximately completely selective towards fluoride. By using an accurate burette with anti-diffusion capillary preventing leakage of standard solution into the solution, small volumes of concentrated sodium fluoride can be added without significantly changing the pH. By multiple additions of standard as described by Nagy (Light Metals Proceedings, 1978, pp. 501-516) the electrode EMF is calibrated against the added concentration of sodium fluoride so that the total fluorine concentration can be calculated. Correction of the fluoride concentration with respect to pH is not significant and can therefore be omitted.

Limits of detection for this methodology are verified to be in the range of 1 ppb. Aarhaug (Metrohm Information 33 (2004) 3, pp. 16-19) reported accuracy to be better than 5% for analysis of samples containing 10 ppb fluoride.

Complexation and precipitation of fluorides is low at low pH (FIG. 2). The methodology in itself is therefore relatively tolerant towards moderate amounts of interfering metals and other cations. In cases where the amount of interferences is high, phosphoric acid is added for complexation and precipitation of cations of aluminium, iron, calcium and magnesium. This prevents precipitation of fluorides causing erroneous analysis. The method is therefore suited for several industrial applications.

The analytical method is characterized by its simple method to obtain very fast, selective and accurate method for fluoride analysis. The method has good tolerance towards interferences. For online applications the limit of detection is a function of the electrode kinetics. Thus, this methodology is very applicable for online monitoring of fluoride.

### ANALYSIS IMPLEMENTATION

The ion selective electrode is comprised of two electrodes; an inner reference electrode and an outer fluoride selective electrode. The inner electrode is in contact with an encapsulated fluoride solution, and thus, providing a fixed response. The outer electrode is immersed into a solution of unknown fluoride concentration. The sensitivity towards fluoride is realized by a fluoride membrane connecting the outer sample and the inner fluoride solution. This membrane is very often lanthanum fluoride, sometimes doped with europium for improved conductivity. Dependent on the difference in fluoride concentration on each side of the membrane, a potential difference is established. This potential difference causes current to run, measured by an ion meter. Relative to the inner reference, the net response for the fluoride electrode is only dependent on the fluoride content of the sample.

Shielded electrode wires are used to prevent noise pickup.

To close the electric circuit, a reference electrode is needed. Normally, a silver/silver halide electrode is used. This electrode is not polarized by the fluoride content of the solution.

Multipoint standard addition methodology is used for calibration.

By connecting the fluoride selective electrode to an ion meter the electromotive force (EMF) is recorded. This value is proportional to the fluoride concentration to which the electrode is exposed. This relation is given by the Nernst equation:

E=E⁰−(RT/F)ln[F⁻]

The relation between concentration and electromotive force is logarithmic.

The correlation between electromotive force and added fluoride concentration is found by regression so that the original electrode potential in solution represents its total fluoride concentration.

As mentioned before, there is no linear correlation between potential and concentration for ion selective electrodes. For regression, either a non-linear model must be used or linearization applied. According to the invention, the method uses algorithms that linearize the correlation. This is documented by Kalman Nagy (Evaluation of the Fläkt Sintalyzer, a new semi-automatic system for fluorine analysis within the aluminium industry, TMS, Denver, 1978).

To lower the pH to less than 2 a strong acid, preferably hydrochloric acid, is used. Concentrated hydrochloric acid diluted by distilled water is approximately free from fluoride, and thus, will not interfere with the analytical result. Normally, the acid strength is chosen so that pH is in the range 0-0.5.

Chloride will provide a reference point for chloride based reference electrodes, thus providing a fast response of the reference electrode. When a stable electrode potential is obtained for the electrode system, additional potentials for the added fluoride standard concentrations are recorded. This could be e.g. a sodium fluoride standard solution.

For online applications, the dynamic changes are often of interest as is absolute content of fluoride. A pre calibration of the electrode for given fluoride concentrations as before mentioned is in many cases sufficient in order to provide online concentrations of fluoride.

As hydrogen chloride is volatile, for online application in open system use of a less volatile acid as e.g. phosphoric acid is required.

For complexation and precipitation of interfering metals, phosphoric acid is used. pH is then lower than 2, preferably in the range 1 to 1.5.

Fluorine in biological materials like grass and needles is mainly found as dust in the form of NaF, AlF₃, Na₃AlF₆, CaF₂ etc. Small amounts are often organically bound. Samples are dried and finely grounded before dissolved in acid. The extraction time varies with the sample material and must be verified by comparison with material of known fluoride content.

### EXAMPLE 1

### Wet Extraction of Fluoride from Needles and Grass

The biological sample is finely ground to a sieve diameter of 0.7 mm. Masses in the range 0.5 to 2 grams are dissolved in a 1:1 mixture of hydrochloric acid (0.5 M) and phosphoric acid (0.5 M). Fluoride analysis is performed directly in the extraction beaker where the initial electrode potential is recorded followed by one or more standard additions. The sample concentration of fluoride is found by correlating the electrode potential to the added concentrations of fluoride.

### EXAMPLE 2

Shell is removed and the meat finely ground by a hand blender or a food processor. For shrimps shells can be left on if its fluoride content should be recorded. Krill is directly ground. As the fluoride concentration will vary with the sampling location, the masses used must be adapted accordingly. This is a compromise between sufficient fluoride content and too much solid material in the analysis beaker. The mass chosen is dissolved in a 1:1 mixture of hydrochloric acid (0.5 M) and phosphoric acid (0.5 M). The extraction period is typically between 8 and 24 hours. This could be verified by comparison with another methodology like alkaline fusion. The analysis of fluoride is performed directly in the extraction beaker as described in Example 1.

1. Method for potentiometric analysis of fluoride in biological materials, comprising:
wet extracting the biological material in a beaker;
analyzing the fluoride concentration in the same beaker; and
where the sample is dissolved in an acid at a pH lower than 2.

2. Method according to claim 1, further comprising the acid being hydrochloric acid and/or phosphoric acid.

3. Method according to claim 1, further comprising adding phosphoric acid to complex or precipitate interfering cations as phosphates when present.

4. Method according to claim 1, further comprising using ultrasound in order to reduce time consumption for extraction in the acid.

5. Method of claim 1, further comprising analyzing fluorides in biological samples in locations near aluminium industry and/or glassworks.
